(19) United States
(12) Patent Application Publication
(10) Pub. No.: US 2011/0187940 A1
(43) Pub. Date: Aug. 4, 2011

(54) DISPLAY APPARATUS

(76) Inventor: Masahiro Hirano, Fukaya-shi (JP)

(21) Appl. No.: 12/901,989

(22) Filed: Oct. 11, 2010

(30) Foreign Application Priority Data
Feb. 3, 2010 (JP) 2010-022356

(51) Int. Cl. H04N 5/66

(52) U.S. Cl. 348/739

(57) ABSTRACT

A display apparatus includes: a main body comprising a display panel; a front panel surrounding the display panel and comprising a front face having a joining surface which is formed with a recess; and a decorative plate that is joined to the joining surface of the front panel.

### CROSS-REFERENCE TO THE RELATED APPLICATION(S)

The present application is based upon and claims priority from prior Japanese Patent Application No. 2010-022356, filed on Feb. 3, 2010, the entire contents of which are incorporated herein by reference.

### FIELD

Embodiments described herein generally relate to a display apparatus having a flat display panel.

### BACKGROUND

In recent years, the screen sizes of flat TV receivers using a liquid crystal panel, a PDP (plasma display panel), or a like display panel have increased and many kinds of flat TV receivers of 40 inches or more (the diagonal length of the effective screen area) have been put on the market. As for the outside appearance of a flat TV receiver, when viewed from the front side, it looks like an assembly of a rectangular, flat-plate-shaped display panel having a screen aspect ratio 16:9 (long in the horizontal direction), a generally rectangular, picture-frame-shaped front cover which surrounds the display panel, and a stand (main components).

In particular, the front cover determines the impression of the appearance of the flat TV receiver and is thus important in design. If a scratch exists in the front cover or it is distorted, the commercial value of the flat TV receiver is much lowered. In view of this, various measures have been proposed that are directed to assembling methods or components of the front cover.

For example, a cabinet has been invented which houses a display module and inclues a front frame and a rear frame. An example of such configuration is disclosed in JP-A-2009-088982. The front frame inclues a front-side front frame and a rear-side front frame. The front-side front frame is a transparent plate and is connected to the rear-side front frame by double-sided adhesive tapes. The surface, connected to the rear-side front frame, of the front-side front frame is coated with a coloring agent. To facilitate assembling, the rear-side front frame is divided into plural frames that are mainly corner portions. No adhesive is applied to prescribed ranges centered by the positions of fastening members for fixing, whereby forces acting on the front-side front frame are weakened.

In many cases, a decorative plate is attached to the front cover of a flat TV receiver and is prone to be distorted in the case where the flat TV receiver is large. In many cases, the decorative plate is a picture-frame-shaped thin plate as a whole or a combination of bracket-shaped or L-shaped thin plates and is bonded to the front cover or connected to it with screws or the like.

Being a thin plate(s), the decorative plate is very likely deformed so as to conform to the shape of the front cover in portions that are connected to the front cover. Therefore, the surface(s) of the front cover to which the decorative plate is joined is required to be high is flatness. It is desirable that that surface (those surfaces) of the decorative plate be kept highly flat even after the front cover is joined to a rear cover or the main body.

Boss portions of the front panel that correspond to connecting portions of the front cover and the rear cover or the main body tend to be deformed by stress that is caused by an injection molding sink or connected portion. Therefore, the decorative plate is prone to be deformed so as to conform to a deformed portion of the front panel and is distorted or undulated in those portions. In particular, where the decorative plate thus deformed has a glossy surface, the appearance may be much degraded.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a perspective view showing a general appearance of a display apparatus according to an embodiment of the present invention.

FIG. 2 is a side sectional view of the display apparatus.

FIG. 3 is a front view of a decorative plate.

FIG. 4 is a front view of a front panel.

FIG. 5 is an enlarged view of one recess.

FIG. 6 is an enlarged view of a circular recess.

FIG. 7 shows a state that double-sided adhesive tapes are laid on the front panel.

FIG. 8 is a side view of a top part of a front cover.

FIG. 9 is a side view of top parts of the front cover and a back cover that are joined together.

### DETAILED DESCRIPTION

According to the embodiments described herein, there is provided a display apparatus including: a main body comprising a display panel; a front panel surrounding the display panel and comprising a front face having a joining surface which is formed with a recess; and a decorative plate that is joined to the joining surface of the front panel.

Embodiments according to the present invention will be described in detail with reference to the accompanying drawings. The scope of the claimed invention should not be limited to the examples illustrated in the drawings and those described in below.

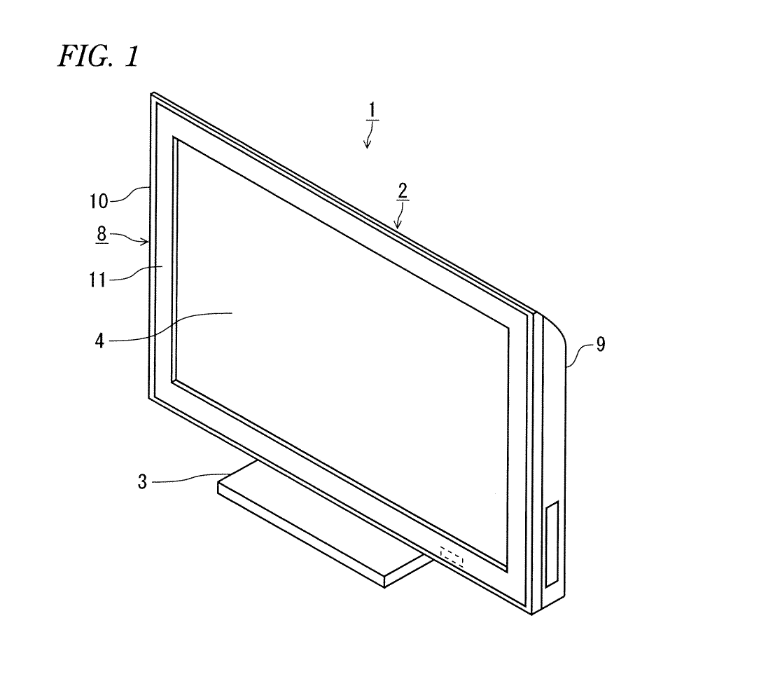

An embodiment of the present invention will be hereinafter described with reference to FIGS. 1-9.

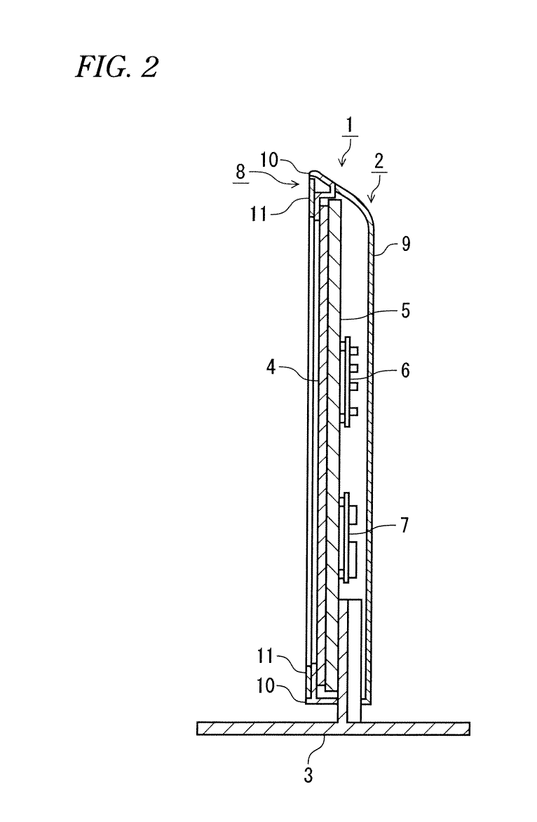

FIG. 1 is a perspective view showing a general appearance of a display apparatus 1 according to the embodiment. FIG. 2 is a side sectional view of the display apparatus 1. The display apparatus 1 is equipped with a main body 2 and a stand 3 which supports the main body 2. In the main body 2, a display panel 4 such as a liquid crystal panel or a PDP is disposed on the front side and a chassis 5 which supports the display panel 4 is disposed behind the display panel 4.

A circuit board 6 and a power circuit board 7 for driving the display panel 4 are disposed behind the chassis 5. A front cover 8 is a cover member for the front side and parts of the top side, bottom side, and both lateral sides of the main body 2 and a back cover 9 is a cover member for the back side and the other parts of the top side, bottom side, and both lateral sides of the main body 2.

The front cover 8 is shaped like a generally rectangular picture frame and thus surrounds the display panel 4, and is component that determines the impression of the appearance of the display apparatus 1. The front cover 8 includes a front panel 10 which surrounds the display panel 4 and a decorative plate 11 which is joined to the front surface of the front panel 10.

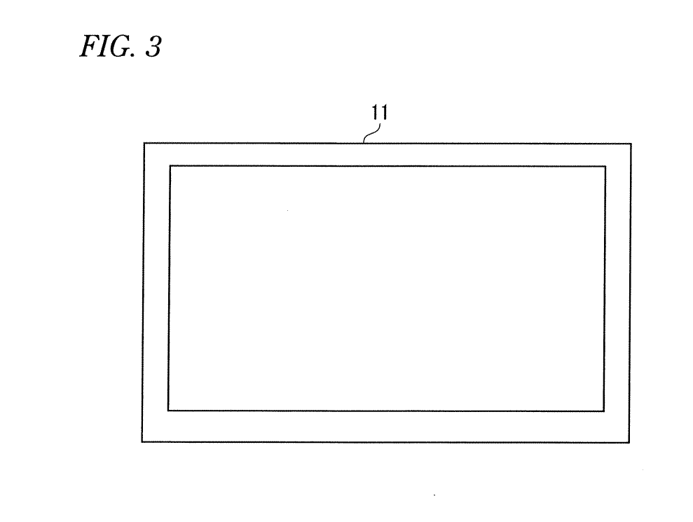

FIG. 3 is a front view of the decorative plate 11. The decorative plate 11 is a picture-frame-shaped thin plate as a whole, and is formed by injection molding using a transparent or semi-transparent resin. The surface, to be joined to the front panel 10, of the decorative plate 11 may be painted. The front side of the decorative plate 11 is flat and may have a glossy surface like a mirror surface.

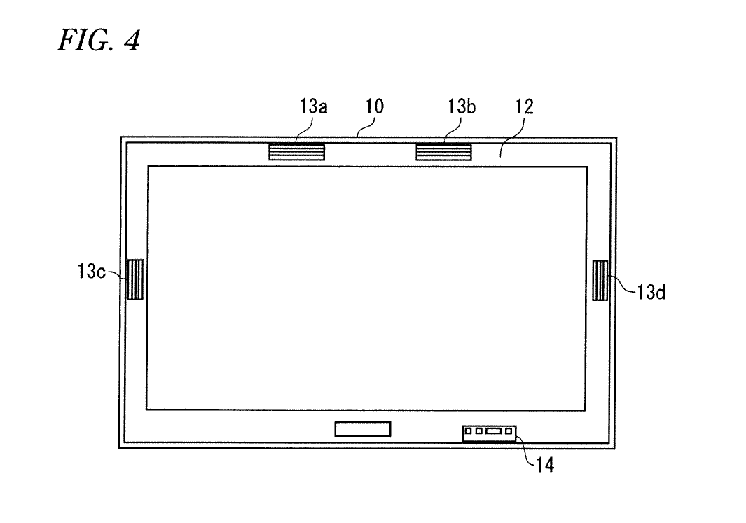

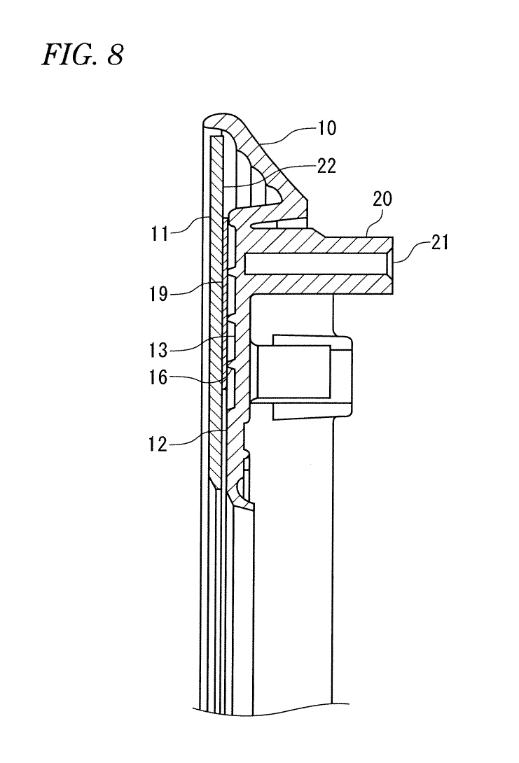

FIG. 4 is a front view of the front panel 10. The front panel 10 is shaped like a picture frame as a whole and is a main component of the front cover 8. The front panel 10 is joined to the chassis 5 and the back cover 9. To this end, the back surface of the front panel 10 is formed with plural bosses 20 (see FIG. 8). The front panel 10 has an opening 14 where an operation indication unit is provided. The decorative plate 11 is bonded to the front surface of the front panel 10 with double-sided adhesive tapes or the like.

The joining surface 12, to be joined to the decorative plate 11, of the front panel 10 is formed with recesses 13 at positions corresponding to the regions (in the surface of the front panel 10 opposite to the joining surface 12) where the respective bosses 20 exist. The recesses 13 are plural recesses 13a-13d which are arranged along the picture-frame-like shape. In the example of FIG. 4, four recesses 13, that is, two top recesses 13a and 13b, a left recess 13c, and a right recess 13d, are formed in total.

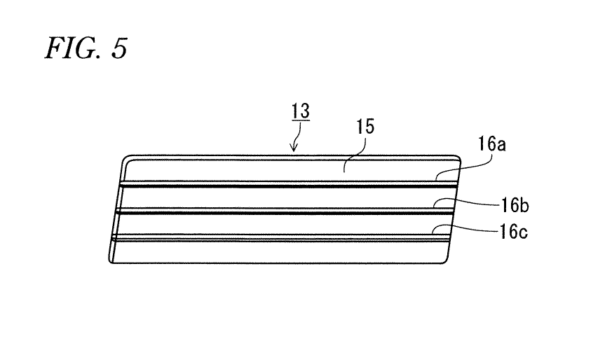

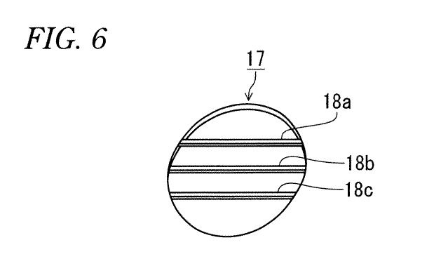

FIG. 5 is an enlarged view of one recess 13. The depth of a bottom surface 15 of the recess 13 as measured from the joining surface 12 is 0.5 to 2 mm. The recess 13 has one or more ribs 16. In the example of FIG. 5, three ribs 16a-16c are formed. The top of each rib 16 is approximately flush with the joining surface 12. Whereas the recess 13 shown in FIG. 5 is generally rectangular, each recess 13 may be circular or elliptical. FIG. 6 is an enlarged view of a circular recess 17. The recess 17 also has one or more recesses 18. In the example of FIG. 6, three ribs 18a-18c are formed.

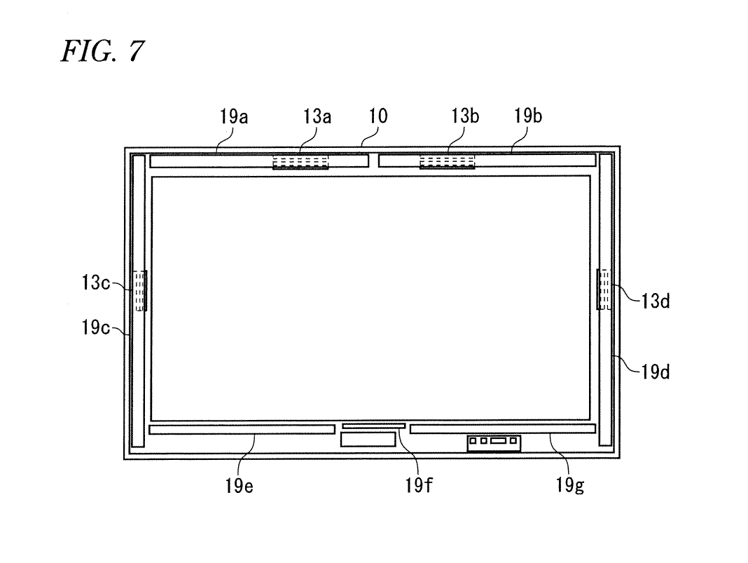

FIG. 7 shows a state that double-sided adhesive tapes 19 are laid on the front panel 10. The double-sided adhesive tapes 19 are laid on the front panel 10 before the decorative plate 11 is joined to it with the double-sided adhesive tapes 19. In the example of FIG. 7, seven divisional double-sided adhesive tapes 19a-19g are used. Furthermore, in the example of FIG. 7, the double-sided adhesive tapes 19a and 19b have the same size, the double-sided adhesive tapes 19c and 19d have the same size, and the double-sided adhesive tapes 19e and 19g have the same size. The use of sets of double-sided adhesive tapes 19 having the same size can reduce the number of kinds of double-sided adhesive tapes 19 and make the tape laying process more efficient. The number of divisional double-sided adhesive tapes 19 may be an arbitrary number. It goes without saying that the sizes of all of the double-sided adhesive tapes 19 may be different from each other.

The double-sided adhesive tapes 19a-19d are laid so as to pass over the ribs 16 of the respective recesses 13a-13d.

Since the plural ribs 16 are arrange at prescribed intervals, the total bonding area is decreased and the adhesion is reduced accordingly in each recess 13. As a result, the decorative plate 11 is joined to the front panel 10 with proper adhesion. The adhesion can be adjusted by changing the number or width of the ribs 16.

Since the plural ribs 18 are arranged at prescribed intervals in each recess 13, the associated double-sided adhesive tape 19 is not bonded to the bottom surface 15 of the recess 13 when the double-sided adhesive tape 19 is laid over the recess 13. If no ribs 16 were formed, a double-sided adhesive tape 19 might be bonded to the associated recess 13 to lower the flatness of the decorative plate 11 when the decorative plate 11 is joined to the front panel 10. If no ribs 16 were formed, the decorative plate 11 would not be bonded to the front panel 10 at all in the regions of the recesses 13 and hence might become loose there.

As described above, the decorative plate 11 is joined to the front panel 10 after the double-sided adhesive tapes 19 are laid on the front panel 10. The double-sided adhesive tapes 19 may be laid on the decorative plate 11 first so that they will cover the ribs 16 when the decorative plate 11 is joined to the front panel 10.

FIG. 8 is a side view of a top part of the front cover 8. FIG. 8 shows a state that the decorative plate 11 is joined to the front panel 10 with the double-sided adhesive tapes 19. The recess 13 is formed in the joining surface 12 which is joined to the decorative plate 11 at the position (in the surface of the front panel 10 opposite to the joining surface 12) corresponding to the region where the boss 20 exists. The boss 20 is formed with a screw hole 21 into which a screw is to be screwed to connect the front cover 8 to the back cover 9 or to the main body 2.

In each recess 13, the double-sided adhesive tape 19 is bonded to only the ribs 16, as a result of which the total bonding area is small and the adhesion between the front panel 10 and the decorative plate 11 is weak. Since the decorative plate 11 is joined to the front panel 10 with proper adhesion, the decorative plate 11 can be prevented from being distorted or reduced in the level of a distortion even if, for example, it is distorted in the region of a recess 13 because of an injection molding sink.

If no ribs 16 were formed in each recess 13, the decorative plate 11 would not be bonded to the front panel 10 at all in the regions of the recesses 13 and hence outer extended portions of the decorative plate 11 might become loose and be distorted. In contrast, securing proper adhesion by means of the ribs 16 makes it possible to prevent the outer extended portions of the decorative plate 11 from being deformed while preventing the decorative plate 11 from being affected by a sink.

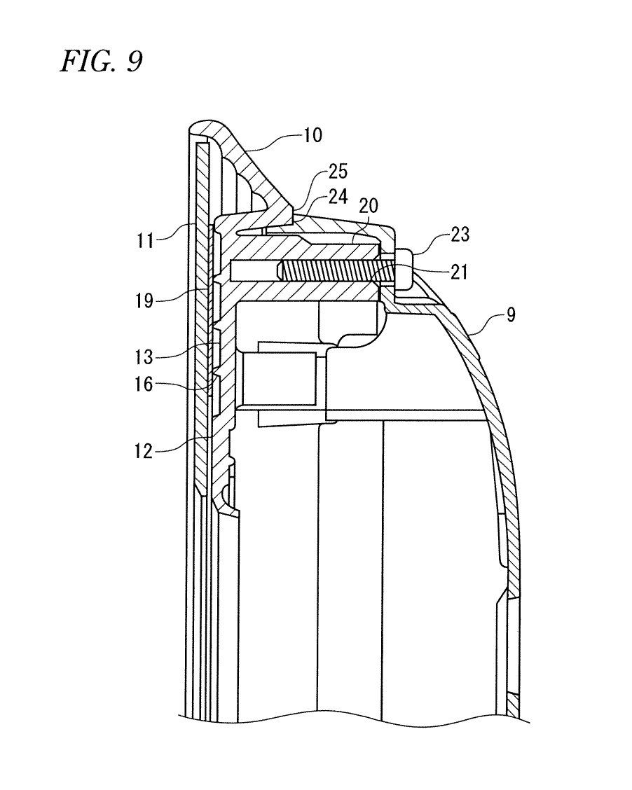

FIG. 9 is a side view of top parts of the front cover 8 and the back cover 9 that are joined together. That is, FIG. 9 shows a state that the decorative plate 11 is joined to the front panel 10 with the double-sided adhesive tapes 19. The back cover 9 is connected to the front cover 8 with screws 23.

When the screw 23 is screwed into the screw hole 21, a contact portion 24 of the back cover 9 comes into contact with a contact portion 25 of the front panel 10. When the screw 23 is screwed further, a backward force acts on the boss 20 and serves to deform the boss 20 and the recess 13. This may produce a slight deformation.

In each recess 13, the double-sided adhesive tape 19 is bonded to only the ribs 16, as a result of which the total bonding area is small and the adhesion between the front panel 10 and the decorative plate 11 is weak. Since the decorative plate 11 is joined to the front panel 10 with proper adhesion, the decorative plate 11 can be prevented from being distorted or reduced in the level of a distortion even if the front panel 10 is deformed by stress that is caused by the joining of the front panel 10 and the back cover 9.

Although the embodiments according to the present invention have been described above, the present invention may not be limited to the above-mentioned embodiments but can be variously modified. Components disclosed in the aforementioned embodiments may be combined suitably to form various modifications. For example, some of all components disclosed in the embodiments may be removed or may be appropriately combined.

Additional advantages and modifications will readily occur to those skilled in the art. Therefore, the invention in its broader aspects may not be limited to the specific details and representative embodiments shown and described herein.

Accordingly, various modifications may be made without departing from the spirit or scope of the general inventive concept as defined by the appended claims and their equivalents.

What is claimed is:

1. A display apparatus comprising:
a main body comprising a display panel;
a front panel surrounding the display panel and comprising a front face having a joining surface which is formed with a recess; and
a decorative plate that is joined to the joining surface of the front panel.

2. The apparatus of claim 1,
wherein the recess is formed in the joining surface of the front panel at a position corresponding to a region where a boss exists in a surface of the front panel that is opposite to the joining surface.

3. The apparatus of claim 1,
wherein the front panel is formed to have a picture frame shape and plural recesses are arranged along the picture frame shape.

4. The apparatus of claim 1,
wherein one or more ribs are formed in the recess.

5. The apparatus of claim 2,
wherein the boss is formed with a screw hole.

6. The apparatus of claim 5,
wherein a screw is screwed in the screw hole so as to connect the front cover to a back cover or the body structure.

7. The apparatus of claim 1,
wherein the decorative plate is joined to the front panel with a double-sided adhesive tape.

8. The apparatus of claim 4,
wherein a double-sided adhesive tape is laid on one or more of the ribs.
